(19) United States
(12) Patent Application Publication
(10) Pub. No.: US 2017/0144661 A1
(43) Pub. Date: May 25, 2017

(54) VEHICLE SPEED CONTROL SYSTEM

(71) Applicant: Ford Global Technologies, LLC, Dearborn, MI (US)

(72) Inventor: Kenneth James Miller, Canton, MI (US)

(21) Appl. No.: 14/946,950

(22) Filed: Nov. 20, 2015

(51) Int. Cl. B60W 30/14; B60W 40/02; B60T 7/12; B60W 10/06; B60W 30/188; B60T 8/58; B60W 10/18

(52) U.S. Cl. CPC B60W 30/143; B60T 8/58; B60W 40/02; B60W 10/18; B60W 10/06; B60W 30/188; B60T 7/12; B60W 30/06

(57) ABSTRACT

A vehicle is provided with an engine to provide drive torque and a braking system to provide brake torque. The vehicle is also provided with a controller that is programmed to limit vehicle speed to a target speed by controlling at least one of the engine and the braking system to modify its output torque, the target speed being dependent on brake pedal position and a clearance distance between the vehicle and an external object.

### TECHNICAL FIELD

One or more embodiments generally relate to a vehicle system and method for controlling the speed of a vehicle during low speed maneuvering.

### BACKGROUND

Many modern vehicles include cameras and displays that assist a driver in monitoring obstacles in close proximity to the vehicle during low-speed maneuvering, such as while parking or while the vehicle is driving in reverse. Additionally, many modern vehicles include sensors and audio chimes that monitor obstacles in close proximity to the vehicle and then provide a sound (e.g., a “beep”) that changes in frequency as the distance between the vehicle and the obstacle decreases.

Some modern vehicles include parking assist systems that automate certain vehicle functionality during low-speed maneuvering or parking. For example, Ford's “Active Park Assist” is an example of a vehicle system that controls vehicle steering during low-speed maneuvering and parking, after the driver activates the system.

### SUMMARY

In one embodiment, a vehicle is provided with an engine to provide drive torque and a braking system to provide brake torque. The vehicle is also provided with a controller that is programmed to limit vehicle speed to a target speed by controlling at least one of the engine and the braking system to modify its output torque, the target speed being dependent on brake pedal position and a clearance distance between the vehicle and an external object.

In another embodiment, a vehicle system is provided with a controller that is programmed to limit vehicle speed to a target speed responsive to vehicle speed being less than a threshold speed, the target speed dependent on a first clearance distance and at least one of an accelerator pedal position and a brake pedal position. The controller is further programmed to limit a rate of increase of the vehicle speed to a vehicle speed threshold rate in response to a second clearance distance that is greater than the first clearance distance.

In yet another embodiment, a method for controlling vehicle speed is provided. An engine or a braking system is controlled to modify its output torque to decrease the vehicle speed to a target speed in response to vehicle speed being less than a threshold speed; wherein the target speed is dependent on a clearance distance between the vehicle and an external object and a brake pedal position.

As such, the vehicle system and method provides advantages over existing systems by automatically limiting the maximum vehicle speed during low-speed maneuvering. The vehicle system limits the maximum vehicle speed based on clearance, accelerator pedal position and brake pedal position—which provides for increased sensitivity over systems that consider fewer inputs. Additionally, once the obstacle has been cleared (i.e., the clearance distance starts increasing) the vehicle system resets the maximum vehicle speed algorithm by gradually increasing or “ramping” vehicle speed back to normal, rather than abruptly increasing vehicle speed.

### BRIEF DESCRIPTION OF THE DRAWINGS

FIG. 1 is a top view of a vehicle system for controlling the speed of a vehicle, illustrated within a vehicle during a low-speed maneuver between two parked vehicles, according to one or more embodiments;

FIG. 2 is a schematic diagram illustrating the vehicle system of FIG. 1;

FIG. 3 is a schematic block diagram illustrating a control system for controlling the vehicle system of FIG. 1;

FIG. 4 is a graph illustrating how various parameters of the vehicle system of FIG. 1 change over time due to the control system of FIG. 3;

FIG. 5 is a graph representing a portion of vehicle system of FIG. 3, illustrating a relationship between an acceleration request, clearance and a vehicle speed weighting factor, according to one or more embodiments;

FIG. 6 is another graph representing a portion of vehicle system of FIG. 3, illustrating a relationship between an acceleration request, clearance and a vehicle speed weighting factor, according to one or more embodiments;

FIG. 7 is another graph illustrating how various parameters of the vehicle system of FIG. 1 change over time due to the control system of FIG. 3; and

FIG. 8 is a flow chart illustrating a method for controlling the speed of the vehicle of FIG. 1, according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

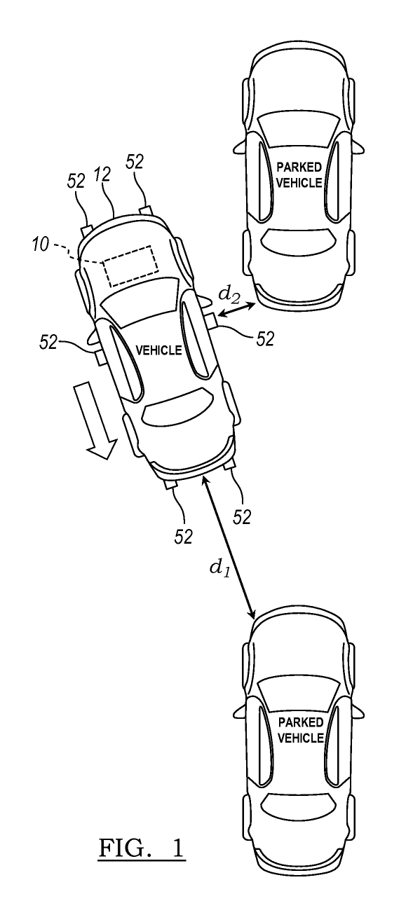

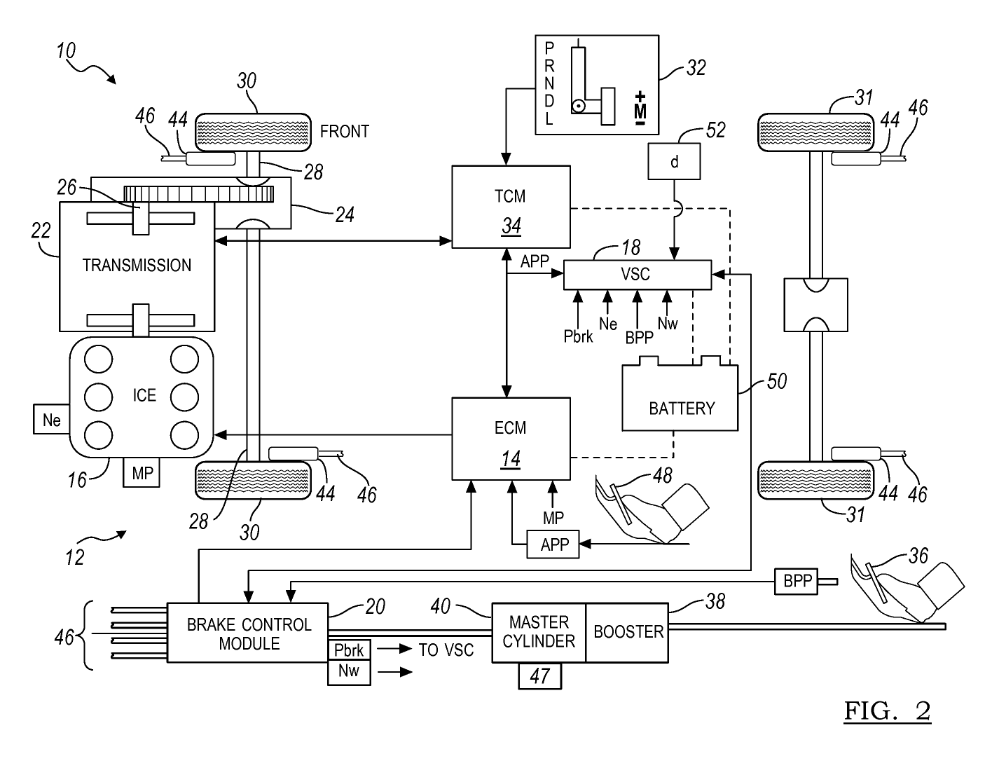

With reference to FIG. 1, a vehicle system for controlling the maximum speed of a vehicle during low speed maneuvering is illustrated in accordance with one or more embodiments and is generally represented by numeral 10. The vehicle system 10 is depicted within a vehicle 12. The vehicle system 10 includes an engine control module (ECM) 14, an internal combustion engine (ICE) 16 and a vehicle system controller (VSC) 18 (shown in FIG. 2), that are in communication with each other. The vehicle system 10 also includes a brake control module 20 (FIG. 2). The VSC 18 receives input that corresponds to the distance (d₁, d₂, dₓ) between the vehicle 12 and obstacles in its proximity, acceleration requests, deceleration requests and vehicle speed. The VSC 18 also communicates with the ECM 14 and the brake control module 20 to limit the maximum speed of the vehicle 12 during low-speed maneuvering. For example, as shown in the illustrated embodiment, the vehicle system 10 limits the speed of the vehicle 12 during parallel parking between two parked vehicles.

Referring to FIG. 2, the vehicle 12 is depicted as a conventional vehicle that is propelled by the engine 16 alone. However, other embodiments of the vehicle system 10 contemplate hybrid vehicle applications (not shown). The vehicle 12 includes a transmission 22 for adjusting the output torque (drive torque) and speed of the engine 16. Torque from the engine 16 is transferred through the transmission 22 to a differential 24 by a transmission output shaft 26. Axle half shafts 28 extend from the differential 24 to a pair of front drive wheels 30. The vehicle also includes rear wheels 31.

The vehicle 12 includes a shifter 32 for manually selecting a transmission gear or mode. In other embodiments the vehicle 12 includes a “shift-by-wire” system (not shown) with an actuator for adjusting a transmission gear in response to a driver selection (e.g., by pressing a button). The shifter 32 includes a sensor (not shown) for providing an output signal that corresponds to a selected transmission gear (e.g., PRNDL). A transmission control module (TCM) 34 communicates with the shifter 32 and the transmission 22 for adjusting the transmission gear ratio based on the shifter selection. Alternatively the shifter 32 may be mechanically connected to the transmission 22 for adjusting the transmission gear ratio.

The vehicle 12 includes a braking system with a brake pedal 36, a booster 38 and a master cylinder 40. The braking system also includes the brake control module 20 that is connected to wheel brake assemblies 44 and the master cylinder 40 by a series of hydraulic lines 46 to effect friction braking. The braking system also includes an actuator 47 that is coupled to the hydraulic lines to increase brake torque in response to a signal from the brake control module 20.

The braking system includes sensors for providing information that corresponds to current braking characteristics. For example, the braking system includes a position sensor for providing a brake pedal position (BPP) signal that represents a driver request for deceleration. In other embodiments, the braking system includes a brake switch (not shown) that provides a signal that indicates whether the brake is applied or released. The braking system also includes one or more pressure sensors for providing a brake pressure (P_{brk}) signal that corresponds to an actual brake pressure value within the brake system (e.g., brake line pressure or master cylinder pressure). The braking system also includes one or more sensors for measuring wheel speed and providing a corresponding wheel speed (N_{w}) signal to the VSC 18.

The vehicle 12 includes an accelerator pedal 48 with a position sensor for providing an accelerator pedal position (APP) signal that represents a driver request for acceleration. The ECM 14 controls the throttle of the engine 16 based on the APP signal.

The vehicle 12 includes an energy storage device, such as a battery 50. The battery 50 supplies electrical energy to the vehicle controllers, as generally indicated by dashed lines in FIG. 2. The vehicle 12 may include a single battery 50, such as a conventional low voltage battery, or multiple batteries, including a high voltage battery (not shown). Additionally, the vehicle 12 may include other types of energy storage devices, such as capacitors or fuel cells.

The vehicle 12 also includes at least one proximity sensor 52 which provides a signal (d) that is indicative of a distance between the vehicle and nearby obstacles. In one or more embodiments, the vehicle 12 includes a plurality of proximity sensors 52 mounted about the exterior of the vehicle 12 that provide signals (d₁, d₂ . . . dₙ). In one embodiment, the proximity sensor 52 is an ultrasonic sensor that emits an acoustic pulse and measures a reflected signal to determine (d). In one or more embodiments, the vehicle 12 also includes a display (not shown) that provides an image of the vehicle 12 relative to any nearby external obstacles based on d.

The VSC 18 communicates with other vehicle systems, sensors and controllers for coordinating their function. As shown in the illustrated embodiment, the VSC 18 receives a plurality of input signals (e.g., APP, BPP, P_{brk}, engine speed (Ne), wheel speed (Nw), etc.) from various vehicle sensors and controllers. Although it is shown as a single controller, the VSC 18 may include multiple controllers to control multiple vehicle systems according to an overall vehicle control logic, or software. The vehicle controllers, including the VSC 18, the ECM 14 and the brake control module 20 generally include any number of microprocessors, ASICs, ICs, memory (e.g., FLASH, ROM, RAM, EPROM and/or EEPROM) and software code to co-act with one another to perform a series of operations. The controllers also include predetermined data, or “look up tables” that are based on calculations and test data and stored within the memory. The VSC 18 communicates with other vehicle systems and controllers (e.g., the ECM 14, the brake control module 20, etc.) over one or more wired or wireless vehicle connections using common bus protocols (e.g., Car Area Network (CAN), Local Interconnect Network (LIN), Media Oriented Systems Transport (MOST), FlexRay, and Ethernet including derivatives of each bus, for example, Audio Video Bridging (AVB) Ethernet).

The VSC 18 communicates with the ECM 14 and the brake control module 20 to limit the maximum vehicle speed during low speed maneuvering based on input signals that correspond to vehicle speed, driver requests for acceleration and deceleration, and vehicle clearance to surrounding obstacles.

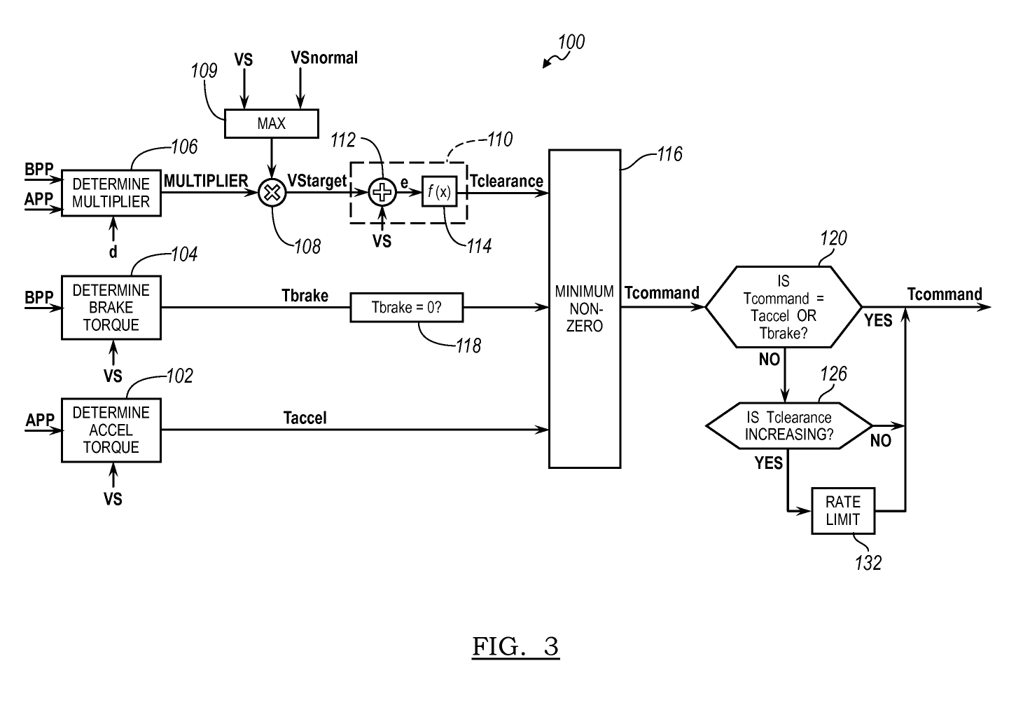

With reference to FIG. 3, a schematic block diagram illustrating operation of a vehicle speed control system is illustrated in accordance with one or more embodiments and generally referenced by numeral 100. The control system 100 is contained within the VSC 18 according to one embodiment, and may be implemented using hardware and/or software control logic as described in greater detail herein. In other embodiments, the control system 100 is distributed amongst multiple controllers, such as the VSC 18, the ECM 14 and the brake control module 20.

The control system 100 determines an acceleration torque command (T_{accel}) at block 102. The control system 100 receives an accelerator pedal position signal (APP) that represents a driver request for acceleration and a vehicle speed signal (VS). The input may be received directly as an input signal from individual sensors or systems, indirectly as data over the CAN bus, or calculated based on other signals. For example, in one embodiment APP is received from the ECM 14 over the CAN bus and VS is calculated based on the wheel speed (Nw) signal received from the brake control module 20 over the CAN bus. Since VS is based on a measured value, it is referred to as an actual vehicle speed. The control system 100 determines T_{accel} using predetermined data that may be referred to as a 3-dimensional map based on APP and VS.

The control system 100 determines a brake torque command (T_{brake}) at block 104. The control system 100 receives a brake pedal position signal (BPP) that represents a driver request for deceleration and the vehicle speed signal (VS). The input may be received directly as an input signal from individual sensors or systems, indirectly as data over the CAN bus, or calculated based on other signals. For example, in one embodiment BPP is received from the brake control module 20 over the CAN bus and VS is calculated based on the wheel speed (Nw) signal received from the brake control module 20 over the CAN bus. The control system 100 determines T_{brake} using predetermined data that may be referred to as a 3-dimensional map, based on BPP and VS.

The control system 100 determines a vehicle speed weighting factor or multiplier (MULTIPLIER) at block 106. The control system 100 receives the accelerator pedal position signal (APP), the brake pedal position signal (BPP) and a clearance distance signal (d) that represents the distance between the vehicle 12 and its surrounding obstacles. The input may be received directly as an input signal from individual sensors or systems, indirectly as data over the CAN bus, or calculated based on other signals. For example, in one embodiment BPP and APP are received over the CAN bus and d is received from the proximity sensor(s) 52. The control system 100 determines MULTIPLIER using predetermined data that may be referred to as a 3-dimensional map based on APP, BPP and clearance distance (d).

The control system 100 determines a maximum vehicle speed target (VS_{target}) at multiplication junction 108. The control system 100 multiplies vehicle speed (VS) by MULTIPLIER to calculate VS_{target}. The control system 100 repeats the steps shown in FIG. 3 multiple times to limit vehicle speed during low speed maneuvering. Since VS is based on a measured wheel speed, it represents actual vehicle speed and it may change during subsequent iterations of the steps shown in FIG. 3. After the vehicle stops, vehicle speed is zero, which would result in a VS_{target} of zero from the multiplication junction 108. To avoid such a zero product, the control system 100 compares VS to a predetermined vehicle speed value (VSₙₒᵣₘₐₗ) at block 109 and selects the larger value to provide to multiplication block 108. VSₙₒᵣₘₐₗ is set to a non-zero low vehicle speed value, e.g., five mph.

The control system 100 determines a clearance torque command (T_{clearance}) at speed controller block 110. The control system 100 calculates a difference between VS_{target} and VS at summation block 112, which represents an error signal (e). Then the control system 100 determines T_{clearance} based on (e) at block 114 using a predetermined function.

The control system 100 determines a torque command (T_{command}) at block 116. The control system 100 compares T_{clearance}, T_{brake} and T_{accel} to each other and sets T_{command} to be equal to the lowest value. The control system 100 also ignores T_{brake} when the brake pedal is not applied, e.g., when T_{brake} is equal to approximately zero, as represented by block 118. For example, in one example of an accelerating condition, T_{clearance} is equal to 30 Nm, T_{brake} is equal to 0 Nm and T_{accel} is equal to 100 Nm. The control system 100 ignores T_{brake} and sets T_{command} to T_{clearance} (i.e., 30 Nm) which is the lowest value. In an example of a decelerating condition, T_{clearance} is equal to −30 Nm, T_{brake} is equal to −50 Nm and T_{accel} is equal to 0 Nm. The control system 100 sets T_{command} to T_{brake} (i.e., −50 Nm) which is the lowest value. In the event that a driver applies both the accelerator pedal and the brake pedal, the control system 100 sets T_{command} to T_{brake} because it will have the lower value.

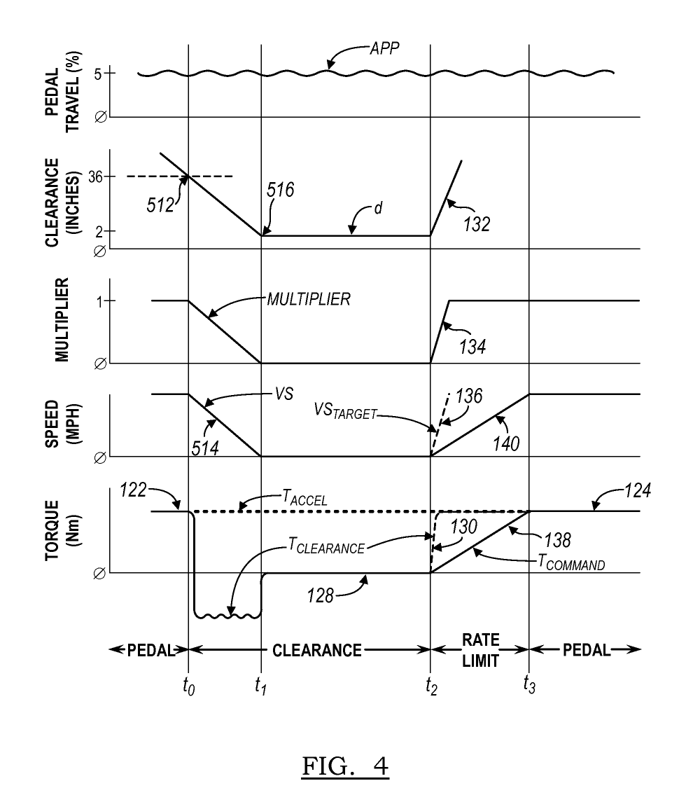

FIG. 4 illustrates the impact of the control system 100 for limiting vehicle speed. FIG. 4 includes five graphs of data taken over a common period of time. Before time (t₀) the torque command (T_{command}) is based on accelerator pedal position, and vehicle speed is not limited by the control system 100. At time (t₀) the control system 100 begins limiting the maximum vehicle speed. Between time (t₀) and time (t₂) the control system 100 limits the maximum vehicle speed based on clearance (d). Between time (t₂) and time (t₃) the control system 100 limits the rate of increase of the torque command (T_{command}). After time (t₃) the torque command (T_{command}) is based on accelerator pedal position, and vehicle speed is not limited by the control system 100.

With reference to FIGS. 3-4, at block 120 the control system 100 evaluates T_{command} to determine if it is based on T_{accel} or T_{brake}. If the determination is positive, the control system 100 provides T_{command} to the ECM 14 or the brake control module 20. FIG. 4 illustrates examples of when T_{command} is equal to T_{accel}, as shown before time (t₁) and after time (t₃) and referenced by numerals 122 and 124, respectively. If T_{command} is based on T_{clearance}, then the control system 100 proceeds to block 126.

At block 126, the control system 100 evaluates T_{clearance} to determine if it is increasing, e.g., if the current T_{clearance} value is greater than the previous T_{clearance} value. If the determination is negative, the control system 100 provides T_{command} to the ECM 14 or the brake control module 20. FIG. 4 illustrates an example of when T_{command} is equal to T_{clearance} and T_{clearance} is not increasing, as shown between time (t₁) and time (t₂) and referenced by numeral 128. If the determination at block 126 is positive, (i.e., T_{clearance} is increasing, as shown at time (t₂) and referenced by numeral 130), then the control system proceeds to block 132. For example, and with reference to FIG. 4, during low speed maneuvering, the vehicle 12 may be in close proximity to an obstacle, e.g., a parked vehicle. However, as the vehicle 12 clears the obstacle, the clearance distance (d) increases (as referenced by numeral 132), which increases MULTIPLIER (as referenced by numeral 134) and results in an increasing VS_{target} (as referenced by numeral 136), and then an increasing T_{clearance} (as referenced by numeral 130). If T_{command} was set equal to T_{clearance} during such a transient event, the vehicle speed would change abruptly.

To avoid an abrupt change in vehicle speed, the control system 100 gradually resets the maximum vehicle speed algorithm by limiting the rate of increase of T_{command} to a threshold rate 138 at block 132. By limiting the rate of increase of T_{command}, the control system 100 controls the vehicle speed to gradually increase, as referenced by numeral 140, rather than follow the transient response of VS_{target} at 136.

Alternatively, in another embodiment, the control system 100 resets the maximum vehicle speed algorithm based on a manual procedure performed by the driver. The control system 100 monitors the accelerator pedal position (APP) and resets the vehicle speed limit in response to a tip-out procedure, i.e., the driver releases the accelerator pedal to 0% travel (tip-out). Other embodiments of the control system 100 contemplate different procedures for manually activating and deactivating the maximum vehicle speed algorithm, e.g., audio commands or through manual input using a user interface.

FIGS. 4-7 include graphs illustrating the 3-D map of predetermined data for determining the vehicle speed weighting factor (MULTIPLIER) in block 106 and waveforms illustrating the impact of the control system 100 on various vehicle parameters, according to one or more embodiments. The control system 100 uses interpolation to determine MULTIPLIER values for variables between the given values, according to one or more embodiments.

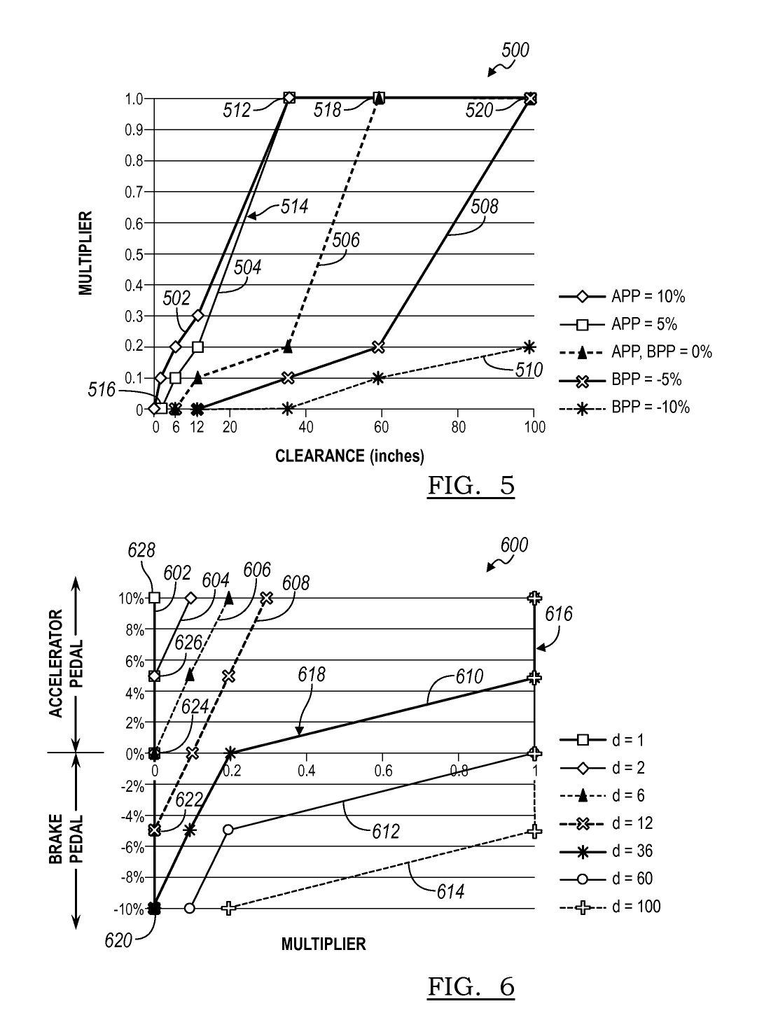

FIG. 5 is a graph 500 illustrating the relationship between the vehicle speed weighting factor (MULTIPLIER) and clearance (d) when acceleration is constant. The graph 500 includes the MULTIPLIER on the y-axis, and (d) on the x-axis. Graph 500 includes five curves representing different brake and accelerator pedal requests. A first curve 502 represents a driver request for moderate acceleration (e.g., APP equals 10% pedal travel), which establishes a maximum MULTIPLIER for a given d. For example, if a driver were to apply the accelerator pedal more than 10% of pedal travel, the MULTIPLIER would be limited to the value provided by the first curve 502 at a given clearance. A second curve 504 represents a driver request for low acceleration (e.g., APP equals 5% pedal travel). A third curve 506 represents a driver request for creep torque by not applying the accelerator pedal or the brake pedal, (e.g., APP and BPP equal 0% pedal travel). A fourth curve 508 represents a driver request for low deceleration (e.g., BPP equals 5% pedal travel). A fifth curve 510 represents a driver request for moderate deceleration (e.g., BPP equals 10% pedal travel).

Referring to FIGS. 4 and 5, the graphs of FIG. 4 and the second curve 504 of FIG. 5 illustrate an example in which the vehicle speed weighting factor (MULTIPLIER) decreases with clearance as acceleration is held constant at 5% pedal position. The maximum vehicle speed is limited (i.e., MULTIPLIER is less than 1) when the clearance is less than thirty-six inches, as referenced by numeral 512. The maximum vehicle speed is gradually decreased, or ramped down, as the vehicle travels from thirty-six inches of clearance to two inches of clearance, as represented by numeral 514. Then the vehicle is stopped at two inches of clearance, as represented by numeral 516.

Graph 500 also illustrates the impact of the brake pedal position and the accelerator pedal position on the control system 100 for limiting vehicle speed. When the driver is applying the accelerator pedal, the control strategy starts limiting vehicle speed when the clearance is less than a relatively small distance (e.g., thirty-six inches), as referenced by numeral 512 (also shown in FIG. 5). When neither the accelerator pedal, nor the brake pedal are applied, the control system 100 starts limiting vehicle speed when the clearance is less than a moderate distance (e.g., sixty inches), as referenced by numeral 518. And when the brake pedal is partially applied e.g., to 5% pedal travel, the control system 100 starts limiting vehicle speed when the clearance is less than a large distance (e.g., one hundred inches), as referenced by numeral 520. By considering brake pedal position, the control system 100 is more sensitive to a driver's request for deceleration and starts limiting vehicle speed at a larger clearance distance as compared to when the brake pedal is not applied.

FIG. 6 is a graph 600 illustrating the relationship between acceleration and the vehicle speed weighting factor (MULTIPLIER) when clearance (d) is constant. Thus, graph 600 illustrates the impact of accelerator and brake pedal position on MULTIPLIER. The graph 600 includes the requested acceleration on the y-axis, and MULTIPLIER on the x-axis. Graph 600 includes five curves representing different clearance (d) values. A first curve 602 represents a clearance of one inch between the vehicle and a surrounding obstacle. A second curve 604 represents a clearance of two inches. A third curve 606 represents a clearance of six inches. A fourth curve 608 represents a clearance of twelve inches. A fifth curve 610 represents a clearance of thirty-six inches. A sixth curve 612 represents a clearance of sixty inches and a seventh curve 614 represents a clearance of one-hundred inches.

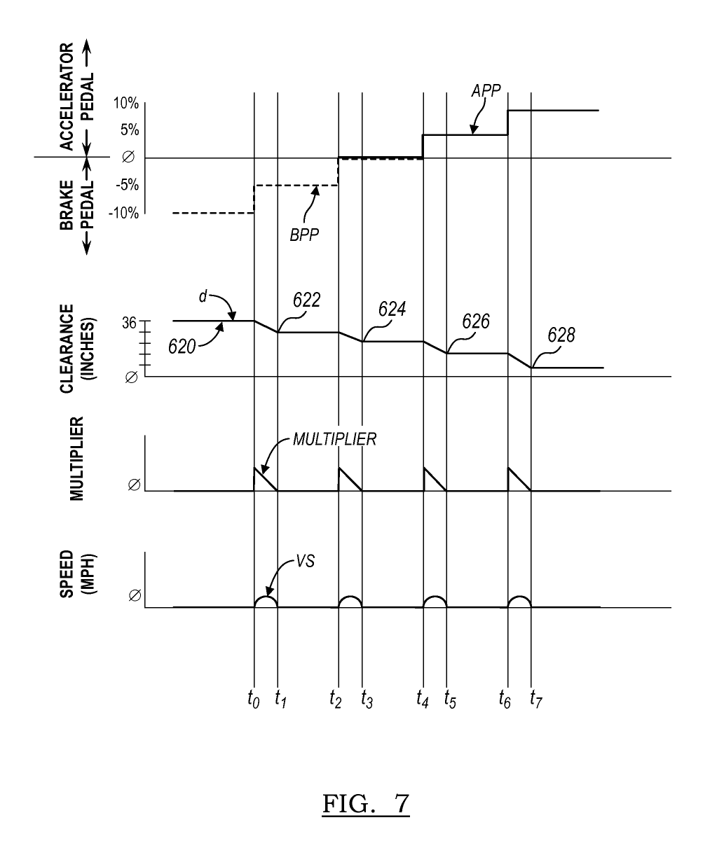

FIG. 7 illustrates the impact of the control system 100 for limiting vehicle speed when acceleration changes. FIG. 7 includes four graphs of data taken over a common period of time.

Referring to FIGS. 6 and 7, the control system 100 allows a driver to control the vehicle 12 to move slowly towards an obstacle. For example, first the driver applies the brake pedal to 10% pedal travel and the control system 100 controls the vehicle 12 to stop at a clearance of thirty-six inches from the obstacle, as represented by numeral 620. At time (t₀), the driver partially releases the brake pedal to 5% pedal travel; and the vehicle 12 moves closer and stops at a clearance of twelve inches from the obstacle, as represented by numeral 622 and time (t₁). At time (t₂), the driver releases the brake pedal to 0% pedal travel; and the vehicle 12 moves closer and stops at a clearance of six inches from the obstacle, as represented by numeral 624 and time (t₃). At time (t₄) the driver partially applies the accelerator pedal to 5% pedal travel; and the vehicle 12 moves closer and stops at a clearance of two inches from the obstacle, as represented by numeral 626 and time (t₅). At time (t₆), the driver applies the accelerator pedal further to 10% pedal travel and the vehicle 12 moves closer and stops at a clearance of one inch from the obstacle, as represented by numeral 628 and time (t₇).

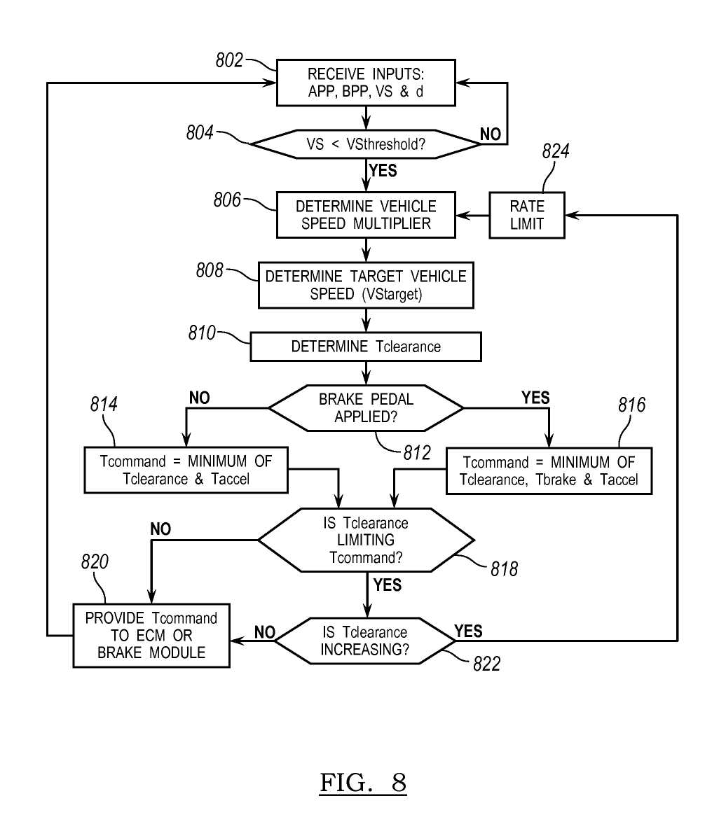

Referring to FIG. 8, a method for limiting the maximum vehicle speed during low speed maneuvering is illustrated according to one or more embodiments and generally represented by numeral 800. The method is implemented as an algorithm using software code contained within the VSC 18, according to one or more embodiments. In other embodiments the software code is shared between multiple controllers (e.g., the VSC 18, the ECM 14 and the brake control module 20).

At operation 802, the VSC 18 receives inputs including: accelerator pedal position (APP), brake pedal position (BPP), vehicle speed (VS) and clearance (d). The VSC 18 receives multiple clearance signals, d₁, d₂, dₙ, and selects the lowest clearance (d). At operation 804, the VSC 18 compares VS to a threshold vehicle speed (VS_{threshold}) to determine if the vehicle 12 is in a low-speed condition (i.e, if VS<VS_{threshold}). In one embodiment VS_{threshold} is equal to ten miles per hour. If the determination is negative, the VSC 18 returns to operation 802, thus the speed limiting algorithm is not available at typical cruising speeds. If VS is less than VS_{threshold}, then the VSC 18 proceeds to operation 806.

At operation 806, the VSC 18 determines a vehicle speed weighting factor (MULTIPLIER) using predetermined data, such as the 3-D map shown in FIGS. 5 and 6. At operation 808, the VSC calculates a target maximum vehicle speed (VS_{target}) as the product of the actual measured vehicle speed (VS) and MULTIPLIER.

At operation 810, the VSC 18 determines a clearance torque (T_{clearance}). The VSC 18 calculates an error signal (e) based on the difference between VS_{target} and VS. Then the VSC 18 calculates T_{clearance} based on e, using a predetermined function.

At operation 812, the VSC 18 evaluates T_{brake} to determine if the brake pedal is applied. If the brake pedal is not applied (i.e., T_{brake} equals zero), then the VSC 18 proceeds to operation 814. At operation 814, the VSC 18 compares T_{clearance} and T_{accel} and sets a torque command (T_{command}) to the lower value. Since the brake pedal is not applied, T_{brake} is not included in the determination of T_{command} at operation 814 to avoid it from biasing the determination. If the brake pedal is applied (i.e., T_{brake} does not equal zero), then the VSC 18 proceeds to operation 816. At operation 816, the VSC 18 compares T_{clearance}, T_{brake} and T_{accel} to each other; and sets T_{command} to the lowest value.

At operation 818, the VSC 18 evaluates T_{command} to determine if it is being limited by T_{clearance}, i.e., if T_{command} was set to T_{clearance} at operation 814 or 816. If T_{clearance} is not limiting T_{command}, the VSC 18 proceeds to operation 820 and provides T_{command} to the ECM 14 or the brake control module 20. The VSC 18 provides positive torque commands (T_{command}) to the ECM 14 for controlling the engine 16 to provide drive torque. The VSC 18 provides negative torque commands (T_{command}) to the brake control module 20 for controlling the braking system to provide brake torque. If T_{clearance} is limiting T_{command}, the VSC 18 proceeds to operation 822.

At operation 822, the VSC 18 evaluates T_{clearance} to determine if it is increasing, e.g., if the current T_{clearance} value is greater than the previous T_{clearance} value. If the determination is negative, the VSC 18 proceeds to operation 820 and provides T_{command} to the ECM 14 or the brake control module 20. If the determination at operation 822 is positive, then the VSC 18 proceeds to operation 824.

At operation 824, the VSC 18 gradually resets the maximum vehicle speed algorithm by limiting the rate of increase of vehicle speed to a threshold vehicle speed rate, which causes vehicle speed to gradually increase. The control system 100 limits the rate of increase of VS to avoid an abrupt change in vehicle speed. The VSC 18 also limits the minimum VS value to a positive setpoint, e.g., five mph, to avoid a zero VS_{target} value at restart conditions.

As such, the vehicle system 10 and method provides advantages over existing systems by automatically limiting the maximum vehicle speed at low vehicle speeds. Further, the vehicle system 10 limits the maximum vehicle speed based on clearance (d), accelerator pedal position (APP) and brake pedal position (BPP)—which provides for increased capability over systems that consider fewer inputs. Additionally, once the obstacle has been cleared (i.e., clearance distance (d) starts increasing) the vehicle system 10 resets the maximum vehicle speed algorithm by gradually increasing or “ramping” vehicle speed back to normal by limiting the rate of increase of vehicle speed directly (i.e., to a vehicle speed threshold rate) or indirectly, by limiting the rate of increase of T_{command} to a torque threshold rate.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
an engine to provide drive torque;
a braking system to provide brake torque; and
a controller programmed to limit vehicle speed to a target speed by controlling at least one of the engine and the braking system to modify its output torque, the target speed being dependent on brake pedal position and a clearance distance between the vehicle and an external object.

2. The vehicle of claim 1 wherein the clearance distance further comprises a first clearance distance, and wherein the controller is further programmed to limit a rate of increase of the vehicle speed to a vehicle speed threshold rate in response to a second clearance distance that is greater than the first clearance distance.

3. The vehicle of claim 1 wherein the controller is further programmed to limit vehicle speed in response to the vehicle speed being less than a threshold speed.

4. The vehicle of claim 1 wherein the target speed is based on an accelerator pedal position, the brake pedal position and the clearance distance.

5. The vehicle of claim 4 wherein the controller is further programmed to generate a weighting factor based on the accelerator pedal position, the brake pedal position and the clearance distance.

6. The vehicle of claim 5 wherein the controller is further programmed to calculate the target speed based on the weighting factor and vehicle speed.

7. The vehicle of claim 5 wherein the clearance distance further comprises a first clearance distance, and wherein the controller is further programmed to:
limit a rate of increase of the drive torque to a torque threshold rate in response to a second clearance distance that is greater than the first clearance distance.

8. A vehicle system comprising:
a controller programmed to:
limit vehicle speed to a target speed responsive to vehicle speed being less than a threshold speed, the target speed dependent on a first clearance distance and at least one of an accelerator pedal position and a brake pedal position; and
limit a rate of increase of the vehicle speed to a vehicle speed threshold rate in response to a second clearance distance that is greater than the first clearance distance.

9. The vehicle system of claim 8 further comprising:
an engine to provide drive torque;
wherein the controller is further programmed to decrease the drive torque to limit vehicle speed.

10. The vehicle system of claim 9 wherein the controller is further programmed to limit the rate of increase of the vehicle speed to the vehicle speed threshold rate by limiting a rate of increase of the drive torque to a torque threshold rate in response to the second clearance distance being greater than the first clearance distance.

11. The vehicle system of claim 8 further comprising:
a braking system to provide brake torque;
wherein the controller is further programmed to increase brake torque to limit vehicle speed.

12. The vehicle system of claim 8 wherein the controller is further configured to limit the rate of increase of the vehicle speed to a vehicle speed threshold rate in response to input indicative of the accelerator pedal releasing to zero percent pedal travel then gradually increasing.

13. The vehicle system of claim 8 wherein the controller is further programmed to generate a weighting factor based on the accelerator pedal position, the brake pedal position and the clearance distance.

14. The vehicle system of claim 13 wherein the controller is further programmed to calculate the target speed based on the weighting factor and vehicle speed.

15. A method for limiting vehicle speed comprising:
controlling an engine or a braking system to modify its output torque to decrease the vehicle speed to a target speed in response to vehicle speed being less than a threshold speed, wherein the target speed is dependent on a clearance distance between the vehicle and an external object and a brake pedal position.

16. The method of claim 15 wherein the clearance distance further comprises a first clearance distance, and wherein the method further comprises increasing the target speed to a non-limited target speed in response to a second clearance distance that is greater than the first clearance distance.

17. The method of claim 15 further comprising:
generating an acceleration torque request based on an accelerator pedal position and vehicle speed;
generating a brake torque request based on the brake pedal position and vehicle speed;
generating a clearance torque request based on a difference between the target speed and the vehicle speed;
setting a torque command to a lowest value of the acceleration torque request, brake torque request and the clearance torque request; and
providing the torque command to the engine or the braking system.

18. The method of claim 17 further comprising setting the torque command to the lowest value of the acceleration torque request and the clearance torque request in response to a brake pedal position indicative of a released pedal.

19. The method of claim 17 further comprising limiting a rate of increase of the torque command to a torque threshold rate in response to setting the torque command to the clearance torque request, and the clearance torque request being greater than a previous clearance torque request.

20. The method of claim 15 wherein the clearance distance further comprises a first clearance distance, and wherein the method further comprises limiting a rate of increase of the vehicle speed to a vehicle speed threshold rate in response to a second clearance distance that is greater than the first clearance distance.
